(19) United States
(12) Patent Application Publication
(10) Pub. No.: US 2021/0199616 A1
(43) Pub. Date: Jul. 1, 2021

(54) SYSTEMS AND METHODS FOR MEASURING DISCRIMINATING REDOX-BASED CHEMICAL SIGNATURES

(71) Applicant: UNIVERSITY OF MARYLAND, COLLEGE PARK, College Park, MD (US)

(72) Inventors: Eunkyoung Kim, Woodstock, MD (US); John Robertson Rzasa, University Park, MD (US); Gregory F. Payne, Hunt Valley, MD (US); William E. Bentley, Annapolis, MD (US)

(21) Appl. No.: 17/136,757

(22) Filed: Dec. 29, 2020

Related U.S. Application Data
(60) Provisional application No. 62/954,895, filed on Dec. 30, 2019.

(51) Int. Cl. G01N 27/327; G01N 27/27; G01N 21/31

(52) U.S. Cl. CPC G01N 27/3277; G01N 21/31; G01N 27/27

(57) ABSTRACT

A method for measuring discriminating redox-based chemical signatures includes adding a chemical input to a body fluid, applying an electrical signal to a combination of the chemical input and the body fluid, measuring an electrical output and an optical output of the combination for a predetermined time period, and determining a cross-modal response that characterizes an interaction between the electrical output and the optical output.

### CROSS-REFERENCE TO RELATED APPLICATION

This application claims the benefit of, and priority to, U.S. Provisional Patent Application No. 62/954,895, filed on Dec. 30, 2019, the entire contents are hereby incorporated by reference.

### TECHNICAL FIELD

The present disclosure relates to systems and methods for measuring discriminating redox-based chemical signatures. More specifically, the present disclosure relates to systems and methods for measuring redox-based chemical signatures of oxidative stress from body fluids.

### BACKGROUND

Development of various diseases, which include cancer, cardiovascular disease, neurodegenerative diseases, neuropsychiatric diseases, and the likes, have been evidenced with links to oxidative stress within body fluid, such as serum or blood. Thus, information of oxidative stress and chemical information in the body fluid can yield valuable markers useful for both researchers and clinicians. However, measurements of the oxidative stress and chemical information in the body fluid have not been easily performed and the cost thereof has been substantially high.

Further, traditionally, chemical information of oxidative stress has been focused on chemically-specific analytic methods, for example, high-performance liquid chromatography (HPLC) and mass spectrometry. Furthermore, instrument-intensive measurements have prevented from rapid, inexpensive, point-of-care analysis that could assist clinicians in diagnosing disease or tailoring treatments for today's patients.

### SUMMARY

The present disclosure relates to systems and methods for measuring discriminating redox-based chemical signatures. Further, to the extent consistent, any of the aspects described in this disclosure may be used in conjunction with any or all the other aspects described herein.

In accordance with aspects of the disclosure, a method for measuring redox-based chemical signatures includes adding a chemical input to a body fluid, applying an electrical signal to a combination of the chemical input and the body fluid, measuring an electrical output and an optical output of the combination for a predetermined time period, and determining a cross-modal response characteristic of an interaction between the electrical output and the optical output.

In various aspects, the chemical input is an iridium-based redox mediator.

In various aspects, the iridium based redox mediator includes Ir or K₃IrCl₆.

In various aspects, the electric signal induces inert reduced iridium of the iridium-based redox mediator into an oxidized form.

In various aspects, the chemical input is configured to exchange electrons with components in the body fluid.

In various aspects, the components include glutathione, ascorbate, or albumin.

In various aspects, the cross-modal response of glutathione, ascorbate, or albumin has a different slope from each other.

In various aspects, the cross-modal response is a slope between the electrical output and the optical output.

In various aspects, the optical output is a measurement of light absorption at a predetermined wavelength.

In accordance with aspects of the disclosure, a system for measuring redox-based chemical signatures of oxidative stress from body fluids, includes an electric circuit configured to apply an electric signal to a combination of a chemical input and a body fluid for a predetermined period, a potentiostat circuit configured to measure an electrical output from the combination when the electrical signal is applied to the combination, an optical absorption meter configured to measure an optical output from the combination when the electrical signal is applied to the combination, a processor, and a memory storing instructions thereon that, which when executed by the processor, cause the system to determine a cross-modal response that characterizes an interaction between the electrical output and the optical output.

In various aspects, the chemical input is an iridium based redox mediator.

In various aspects, the iridium based redox mediator includes Ir or K₃IrCl₆.

In various aspects, the electric signal induces inert reduced iridium of the iridium based redox mediator into an oxidized form.

In various aspects, the chemical input exchanges electrons with components in the body fluid.

In various aspects, the components include glutathione, ascorbate, or albumin.

In various aspects, the cross-modal response of glutathione, ascorbate, or albumin has a different slope from each other.

In various aspects, the cross-modal response is a slope between the electrical output and the optical output.

In various aspects, the optical output is a measurement of light absorption at a predetermined wavelength.

In various aspects, the predetermined wavelength is based on a component of the body fluid.

In accordance with aspects of the disclosure, a non-transitory computer-readable storage medium including instructions stored thereon that, when executed by a computer, cause the computer to perform a method for measuring discriminating redox-based chemical signatures. The method includes applying an electrical signal to a combination of a chemical input and a body fluid, measuring an electrical output and an optical output of the combination for a predetermined time period, and determining a cross-modal response that characterizes an interaction between the electrical output and the optical output.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 illustrates a block diagram of a measurement system for measuring discriminating redox-based chemical signatures in accordance with aspects of the present disclosure;

FIG. 2 is a block diagram of a light source of the measurement system of FIG. 1 in accordance with aspects of the present disclosure;

FIG. 3 is a graphical illustration of inputs and outputs for measuring redox-based chemical signatures of oxidative stress in accordance with aspects of the present disclosure;

FIGS. 4A-4D are graphical illustrations of an electrical input and corresponding outputs for measuring redox-based chemical signatures of oxidative stress in accordance with aspects of the present disclosure;

FIGS. 5A-5F are graphical illustrations of electrical and optical outputs in the presence of glutathione (GSH) in accordance with aspects of the present disclosure;

FIGS. 6A-6F are graphical illustrations of electrical and optical outputs in the presence of ascorbate and albumin in accordance with aspects of the present disclosure;

FIG. 7 illustrates a method for measuring redox-based chemical signatures of oxidative stress in accordance with aspects of the present disclosure; and

FIG. 8 illustrates a block diagram for a computing device in accordance with aspects of the present disclosure.

### DETAILED DESCRIPTION

The present disclosure relates to systems and methods for measuring discriminating oxidation-reduction (redox) reaction-based chemical signatures. More specifically, the systems and methods measure redox-based chemical signatures of oxidative stress from body fluids.

The redox reaction is a type of chemical reaction that involves a transfer of electrons between two species. The redox reaction is any chemical reaction, in which the oxidation number of a molecule, atom, or ion changes by gaining or losing an electron. An increase in oxidative stress can increase the onset of various diseases, such as cancer, cardiovascular disease, neurodegenerative diseases, neuropsychiatric diseases, and the like. Information regarding oxidative stress may be found in a body fluid (e.g., serum or blood). Thus, the chemical information of oxidative stress may yield valuable biomarkers useful for both researchers and medical professionals.

Oxidants (e.g., reactive oxygen and nitrogen species) may be responsible for bodily damage and the onset of disease due to oxidative stress. The endogenously-generated protective antioxidants (e.g., glutathione (GSH), ascorbic acid, or albumin) and proteins are involved in inflammation and protection (e.g., cytokines and defense enzymes), as well as damage associated with oxidative stress (e.g., lipid peroxidation and protein carbonylation).

The systems and methods disclosed in the present disclosure are for diagnosis as well as drug discovery and may be used to develop drugs and the manufacture thereof. Typically, biologics therapeutics may be made in bioreactors growing cells, or host cells within which the drug therapeutic is manufactured. In both cases, the development of cell lines, manufacturing processes, and actual production are carried out in cell culture media that mimics the native environment from which the cells have been obtained. Hence, while the purposes of this disclosure are for diagnosis and discovery, because the test samples are similar to those used in drug development and manufacturing, the systems and methods disclosed in the present disclosure may be equally suited to elucidate conditions that are indicative of proper or improper cell culture or manufacturing conditions.

Samples from bioreactors, raw materials used prior to the reactor, or downstream processing vessels and conduits may be equally important as the original body fluid. For example, many of the redox active species in cell culture media are the same as in freshly drawn body fluids (e.g., glutathione, serum, albumin, ascorbic acid, cysteine-containing proteins, etc.).

In various aspects, machine learning may be used to detect signature differences or determine correlations between the cross-modal response data and extract characterizations of the interaction between the current flow and the optical absorption. In various aspects, the machine learning system may use supervised learning, unsupervised learning, or reinforcement learning. In various aspects, the machine learning may include neural networks such as a temporal convolutional network, a fully connected network, or a feed-forward network.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

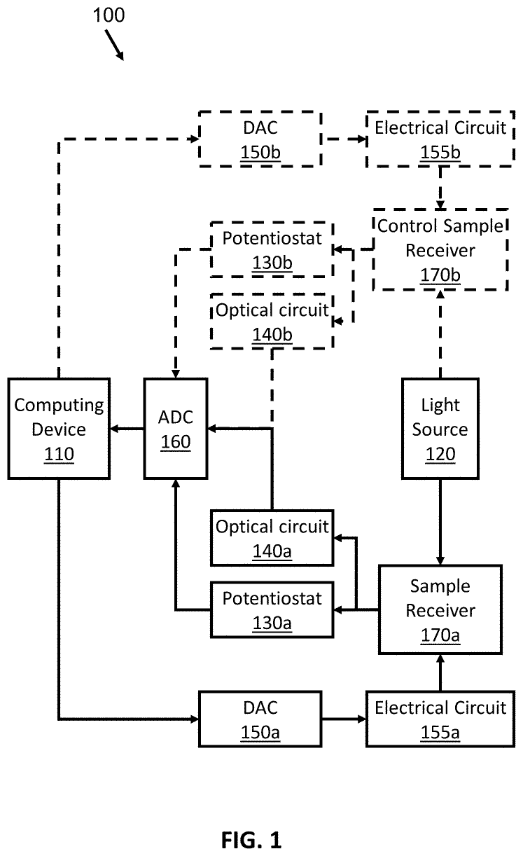

FIG. 1 shows a measurement system 100 for measuring discriminating redox-based chemical signatures in accordance with aspects of the present disclosure. The measurement system 100 may include a computing device 110, two measurement channels, a light source 120, and an analog-to-digital (ADC) converter 160. The first measurement channel may include a digital-to-analog (DAC) converter 150a, an electrical circuit 155a, a potentiostat 130a, an optical circuit 140a, and a sample receiver 170a, and the second measurement channel may include a DAC converter 150b, an electrical circuit 155b, a potentiostat 130b, an optical circuit 140b, and a control sample receiver 170. As shown in dashed lines in the second channel, the second channel may be optional for the measurement system 100.

Since functions of the second channel are substantially the same as the functions of the first channel, descriptions of the second channel can be found at descriptions of the first channel below and thus are omitted herein. The channel indicators “a” and “b” affixed after numerals (e.g., “130,” “140,” “150,” “155,” and “170”) may be removed below in a case when only one channel is used in the measurement system 100. In various aspects, the measurement system 100 may include more than two measurement channels.

The measurement system 100 may have a custom-built graphical user interface (GUI) for control and data acquisition, along with a macro language to run automatic batches of voltage sweeps, impulses, sine waves, and multiple-step profiles. All these features together may allow for quick generation of large datasets for biomarker discovery. In various aspects, different waveforms may be used on the first and second channels. For example, the first channel may use a step waveform, and the second channel may use a sine waveform.

The measurement system 100 may be an autonomous redox discovery platform (ARDP), which is an electro-optical instrumentation system to measure redox-based chemical signatures of oxidative stress from body fluids, for example, manufacturing and/or environmental samples. When a sample is placed on the sample receiver 170, the measurement system 100 may simultaneously measure and analyze electrical and optical output signals from the sample by applying an electric signal and emitting light to the sample. Combination of the electrical and optical output signals may reveal characteristics of the sample. In various aspects, signal metrics may include parameters that characterize optical or electrical waveforms or response times, or cross-modal correlations that characterize interactions between electrical and optical output signals.

In various aspects, the measurement system 100 may simultaneously analyze two samples (e.g., the sample in the first channel and the control sample in the second channel) by applying an electrical signal and emitting light to each sample and simultaneously measuring the electrical and optical output signals from each sample.

The light source 120 may emit broadband light or narrowband light depending on characteristics of the sample. For example, a substance (e.g., GSH) in the sample may absorb a specific frequency of light, and the light source 120 may emit the corresponding light including the specific frequency (e.g., 488 or 490 nanometer (nm)). In various aspects, the light source 120 may be modular so that light emitted from the light source 120 may swap out a range of frequencies when a different wavelength needs to be measured. The light source 120 may utilize a light emitting diode (LED), laser, or any other suitable light source which emits light including frequencies of interest.

The computing device 110 may provide a digital control signal to the DAC converter 150, which then converts the digital control signal to an analog control waveform. The electric circuit 155 may be caused by the analog control waveform to generate an electric control signal. In various aspects, the analog control waveform may directly function as the electric control signal so that the electric circuit 155 may not be included in the measurement system 100.

The electric control signal may be applied to the sample and cause electrons in the sample to move so that an oxidation-reduction (redox) process is facilitated in the sample. Due to the redox process, an electrical output from the sample correspondingly changes. Further, along the redox process, one or more specific frequencies of light may be correspondingly absorbed by the sample based on the substances in the sample.

The electric output from the sample may be measured by the potentiostat 130. The potentiostat 130 is a control and measuring device and includes an electric circuit which controls the potential across the sample by sensing changes in its resistance, and accordingly varying the current supplied to the sample. A higher resistance results in a decreased current, while a lower resistance results in an increased current based on the Ohm's law, which is represented as V=IR, where V is voltage, I is current, and R is resistance.

In various aspects, the potentiostat 130 may include three electrodes: working, reference, and counter electrodes. A voltage may be applied to the counter electrode to maintain a potential between the reference and working electrodes; current at the working electrode may be transformed into a voltage signal by a trans-impedance amplifier; and the reference electrode may be used to measure the potential across the working electrode. The reference electrode generally has a constant electrochemical potential as long there is no current flowing through it.

In various aspects, the light emitted from the light source 120 is collimated, filtered, split in two or three ways, and directed through the potentiostat 130 that performs the potentiostat measurements. It is contemplated that the potentiostat 130 may have any suitable geometric configuration, including a honeycomb shape. It is also contemplated that any suitable light source can be used operating in the range from 350 nm to 3.5 μm. Because of the holes in the honeycomb shape, light can pass through and then be directed to the optical circuit 140. As the reactions in the sample progress, any changes in optical absorption at one or more frequencies may be measured. Because these measurements are occurring at the same time as the potentiostat 130, the electric and optical outputs are directly correlated in time.

The measured electric output from the sample may be digitally sampled by the ADC converter 160. The sampling frequency of the ADC converter 160 may depend on characteristics of components within the sample.

The optical circuit 140 may be an optical absorption meter, which is capable of measuring absorption of the light by the sample while the light source 120 emits the light over the sample. The optical output from the sample measured by the optical circuit 140 may be digitally sampled by the ADC converter 1. In various aspects, the electrical output and the optical output may be simultaneously measured and digitally sampled. In this regard, the ADC converter 160 may include two channels in order for the ADC converter 160 may be capable of digitally sampling the electrical and optical outputs from the potentiostat 130 and the optical circuit 140.

In various aspect, the ADC converter 160 may include four channels for digital sampling when the electrical and optical outputs are measured by the potentiostat 130b and the optical circuit 140b in the second channel. Further, the ADC converter 160 may include more than 4 channels to accommodate a number of channels in the measurement system 100.

The ADC converter 160 may have a resolution of 16 or more bits, or may be capable of adjusting the resolution of digital sampling based on the needs of the measurement system 100. The sampling period by the ADC converter 160 may be as small as one microsecond, while the time error between channels may be within nanoseconds. In various aspects, high-end femtoampere offset op-amps may be used as an amplifier for the optical and electrical outputs to minimize error at low current measurements. A custom field-programmable gate array (FPGA) controller may control each component of the measurement system 100 to ensure tight synchronization in a small form factor.

The digital samples of the electrical and optical outputs are supplied to the computing device 110, which then processes the digital samples and determines characteristics of the sample. The characteristics may be cross-modal relationships between the electrical and optical outputs.

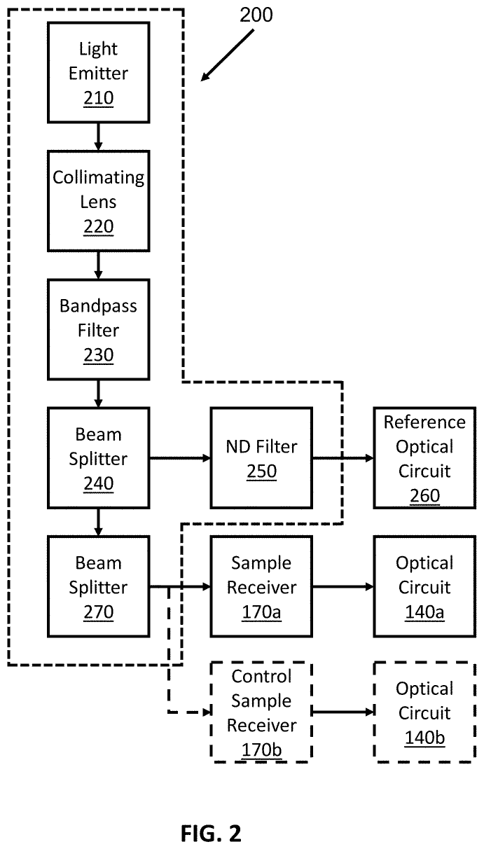

Referring now to FIG. 2, provided is a light source 200, as an example of the light source 120 of FIG. 1, according to aspects of the present disclosure. The light source 200 may include a light emitter 210, a collimating lens 220, a bandpass filter 230, a beam splitter 240, a neutral-density (ND) filter 250, a reference optical circuit 260, and a beam splitter 270. The light emitter 210 may emit any light including LED, ultraviolet light, infrared light, laser, white light, broadband light, narrowband light, and the like. The emitted light may include one or more specific frequencies, for example, 488 nm and 490 nm.

The emitted light may be collimated by the collimating lens 220, and the collimated light is filtered by the bandpass filter 230 to make sure that the filtered light includes one or more frequencies of interest.

The beam splitter 240 may split the filtered light into the ND filter 250 and another beam splitter 270. The ND filter 240 may reduce or modify the intensity of all wavelengths of the split light so that the reference optical circuit 270 may generate a reference value for the light emitted by the light source 200. The reference signal may be used to compensate for drift inherent in the intensity of the light source over time.

The beam splitter 270 may also split the light from the beam splitter 240 into the sample in the sample receiver 170a and the control sample in the control sample receiver 170b so that the optical circuits 140a and 140b may be able to measure light absorption in response to the light emission with the same amplitude and the same band of frequencies.

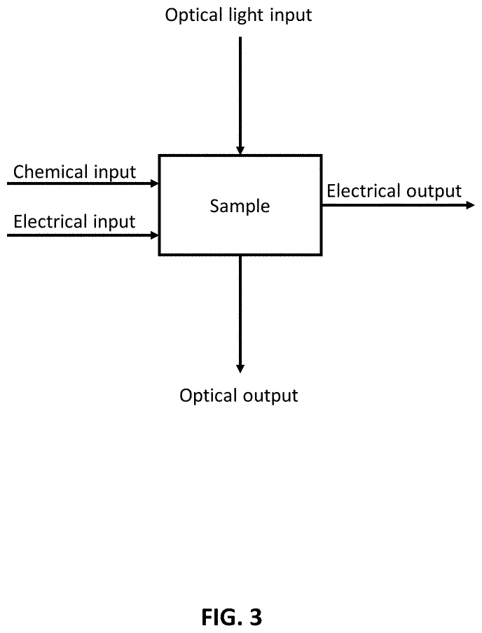

Now referring to FIG. 3, provided is a graphical illustration of inputs and outputs for measuring redox-based chemical signatures of oxidative stress from body fluids in accordance with aspects of the present disclosure. The sample may be probed by supplying a chemical input (e.g., Iridium (Ir) based redox mediator) and an electrical input waveform to the sample. The Ir-based redox mediator (e.g., Ir or K₃IrCl₆) may be activated by the electrical input waveform, and the activated Ir-based redox mediator may exchange electrons with a wide range of components (e.g., GSH, ascorbate, albumin, etc.). The electron exchange may be detected spectroelectrochemically by the simultaneous measurement of electrical and optical output signals.

The electrical input waveform may be a sequence of oxidative voltage pulses that serve to convert the inert reduced iridium (designated Ir^{RED}) into its oxidized form (designated Ir^{OX}), which diffuses into and probes the sample for redox-dependent features (e.g., reactive free radicals, protective reductants, oxidized proteins, etc.). The optical and electrical outputs may be simultaneously measured using a perforated electrode in a spectroelectrochemical cell, which is the combination of the sample and the chemical input.

The light source may emit light through the sample. During the redox reaction, portions of the emitted light may be absorbed. Thus, the other portions of the light, which has not absorbed, may be outputted as the optical output. An optical circuit may measure light absorption by comparing the optical output with the emitted light.

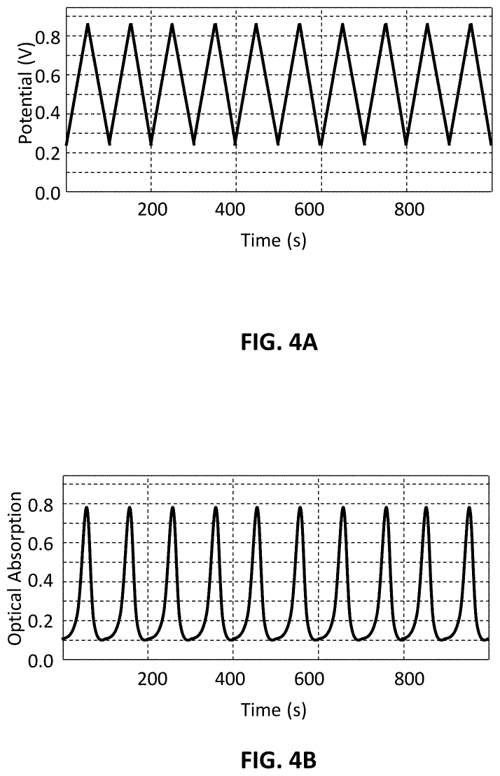

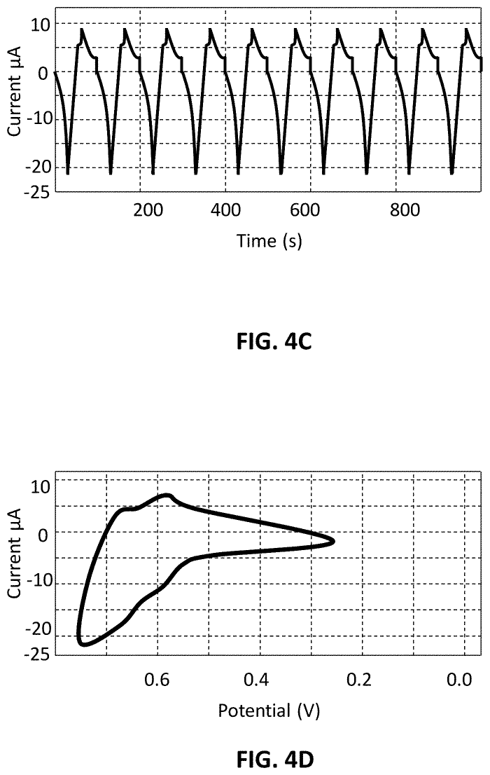

Now referring to FIGS. 4A-4D, provided are examples of an electrical input, an optical output, an electrical output, and a cross-modal response between the optical and electrical outputs, which are measured in the presence of GSH, according to aspects of the present disclosure. The GSH may be mixed with a chemical input, an inert Ir-based redox agent (Ir^{RED}) which may be converted to Ir^{OX} when the electrical input is supplied. The amount of Ir^{RED} provided in the sample is 0.5 millimolar (mM) and may vary so that Ir^{RED} is sufficiently enough to determine characteristics of GSH when Ir^{RED} is activated.

The electrical input includes a periodic saw-tooth waveform as shown in FIG. 4A. The period (about 100 seconds) and the amplitude (about 0.5 volts) of the periodic saw-tooth waveform may be adjusted depending on characteristics of the redox response. For example, the electrical input may be step waves, sine waves, saw waves, triangle waves, and/or other suitable arbitrary waveform. In various aspects, the shape of or any changes in the electrical input may be adjusted depending on characteristics of the redox response of the sample.

The optical absorption as shown in FIG. 4B displays a periodic shape similar to the shape of the electrical input as shown FIG. 4A. The period is about 100 seconds, which is equal to the period of the electrical input. Thus, the optical absorption may correspond to the period of the electrical input.

On the other hand, the electrical output of FIG. 4C shows a more complicated periodic shape than the shapes of the electrical input and the optical absorption. Nevertheless, the period of the electrical output is about 100 seconds, which is the same as the period of the electrical input. As the electrical output also corresponds to the period of electrical input, and the electrical and optical outputs may be simultaneously measured, FIG. 4D shows a graph of the electrical outputs versus to the electrical inputs.

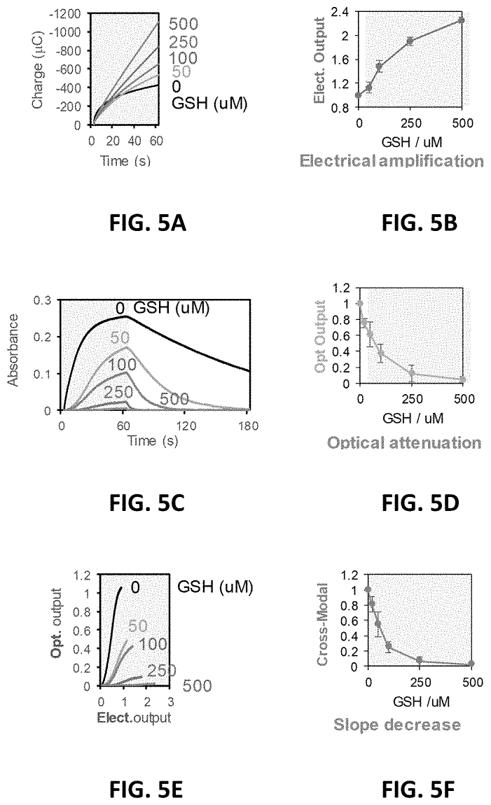

Now referring to FIGS. 5A-5F, provided are graphical illustrations, which show changes in electrical charges and light absorption based on different micromolar concentrations of GSH (e.g., micromolar concentration of GSH) according to aspects of the present disclosure. The graphical illustrations of FIGS. 5A and 5B show electrical outputs depending on different micromolar concentrations of GSH. In particular, FIG. 5A shows curves with the unit of seconds in the horizontal axis and the unit of current charges in the vertical axis, while FIG. 5B shows a line graph with the unit of micromolar concentration in the horizontal axis and the unit of current in the vertical axis. The charges are measured by accumulating current transferred. That is the charge, Q, is equal to “∫ i dt”, where i is current.

The amplitude of the electrical output increases over time during the upslope of the electrical input, and this output charge is amplified in the presence of GSH consistent with an Ir redox-cycling reaction that essentially mediates the transfer of electrons from GSH to the electrode.

In various aspects, the optical output and the electrical output may be normalized so that they can be compared and calculated to determine characteristic relationships between the optical output and the electrical output. For example, the outputs at the end of the period may be normalized to be “one”.

During the time the oxidative electrical input pulse is being provided, the optical output, which is the light absorbance at 488 nm (λmax for Ir^{OX}), is measured depending on the micromolar concentrations of GSH in FIGS. 5C and 5D. The amplitude of the optical output increases during the oxidative on-pulse and this optical output is attenuated in the presence of GSH. Attenuation of the optical output is also consistent with Ir-based redox-cycling.

The curves shown in FIG. 5C show that the more the micromolar concentration of GSH is, the less the specific frequency of light is absorbed. In other words, the more the micromolar concentration of GSH is, the less light is outputted as shown in FIG. 5D.

As described above, the electrical output and the optical output are normalized to have one at 0 micromolar (μM) of GSH at the end of the period, which are evidenced at FIGS. 5B and 5D.

FIGS. 5E and 5F illustrate relationships between the electrical output and the optical output depending on the micromolar concentrations of GSH. The vertical and horizontal axes of FIG. 5E are normalized optical outputs and normalized electrical outputs, respectively. The ratio of the optical output to the electrical output, as a cross-modal response, decreases as the micromolar concentration of GSH increases.

For example, when the micromolar concentration of GSH is zero, the normalized electrical output is one as shown in FIGS. 5B and 5E and the normalized optical output is also one as shown in FIGS. 5D and 5E. Thus, the cross-modal response at zero GSH is about one. In a similar way, when the micromolar concentration of GSH is 500 μM and the electrical output is about 2.3 as shown in FIGS. 5B and 5E, the optical output is close to zero as shown in FIGS. 5D and 5E. Thus, the cross-modal at 500 μM GSH is close to zero. These cross-modals along the micromolar concentrations of GSH are reflected in the line graph as shown in FIG. 5F.

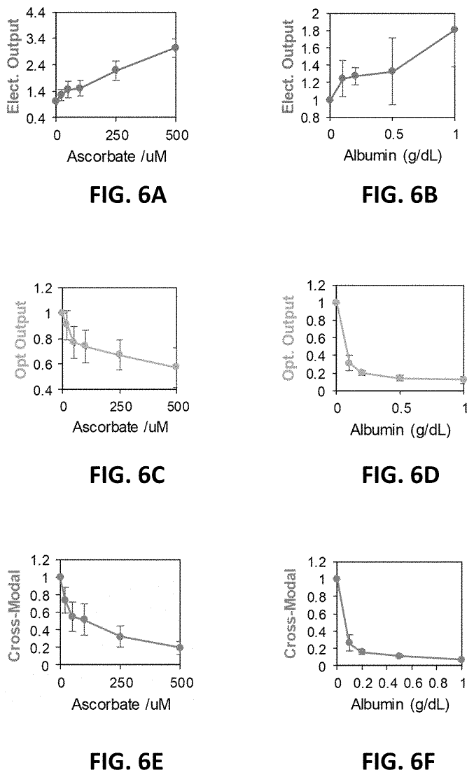

Many substances are included in a body fluid (e.g., blood, serum, etc.). The substances may be ascorbate and albumin in addition to GSH. Generally, GSH, ascorbate, and albumin are accounted for 70-80% of total thiols in blood, where the thiols are likely to be molecular targets of oxidative stress. Electrical outputs, optical outputs, and the corresponding cross-modals are illustrated in FIGS. 6A-6E in the presence of ascorbate and albumin. Similarly as FIGS. 5B, 5D, 5F, 6A, 6C, and 6E show electrical outputs, optical outputs, and cross-modals along the micromolar concentrations of ascorbate in unit of μM, and FIGS. 6B, 6D, and 6F show electrical outputs, optical outputs, and cross-modals along grams per deciliter (g/dL) of albumin.

In various aspects, even though the units of substances are different, the cross-modal responses may be compared to each other by normalizing the outputs. For example, the unit of ascorbate is μM and the unit of albumin is g/dL. The cross-modal at zero substance may be normalized to be one without units as shown in FIGS. 5F, 6E, and 6F so that cross-modal responses of different substances may be compared to each other.

As shown in FIGS. 5F, 6E, and 6F, the cross-modals of GSH, ascorbate, and albumin have patterns or shapes different from each other. Based on these cross-modal patterns, a body fluid may be tested with the Ir-based redox mediator and the electrical input, and cross-modal during the redox reactions may be compared with the cross-modals of FIGS. 5F, 6E, and 6F to identify characteristics of the body fluid.

In another aspect, when the electrical input has another shape (e.g., impulses, sine waves, step, multiple-step profiles, etc.) other than the saw-tooth shape, the cross-modal responses may result in different patterns. Nevertheless, patterns of cross-modal responses of GSH, ascorbate, and albumin are different from each other. Thus, by comparing patterns of cross-modal responses, abnormalities in the substances of the body fluid may be identified.

The cross-modal response is one example, and various metrics that characterize differences in the outputs (e.g., changes in waveform (an amplification, attenuation, rectification or gating of the output), response times (signal decay rates) or cross-correlations (transconductance or cross-modal correlations)) may also be generated.

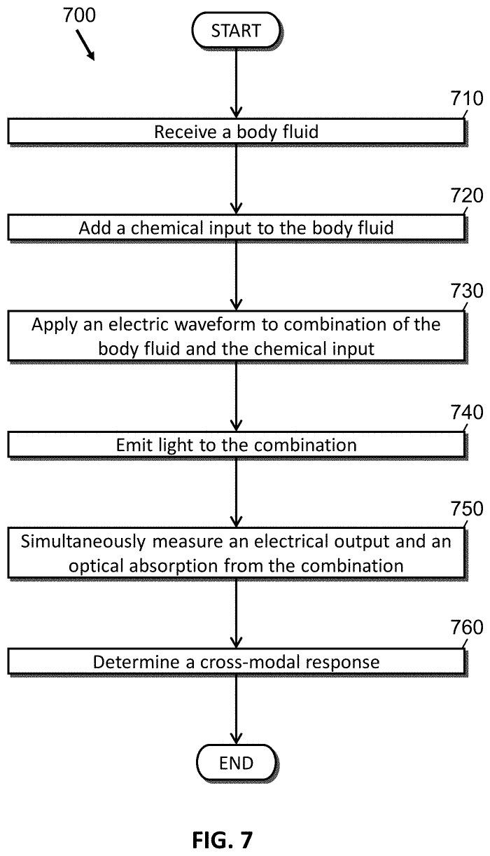

FIG. 7 illustrates a method 700 for simultaneously measuring electrical and optical outputs based on redox reaction according to aspects of the present disclosure. The method 700 starts by receiving a sample in step 710. The sample may be a body fluid, which includes serum antioxidants (e.g., GSH, ascorbate, and albumin).

In step 720, a chemical input is added/supplied to the body fluid. The chemical input may include Ir-based redox mediator. When an electrical waveform is applied to the combination of the body fluid and the chemical input in step 730, the chemical input (e.g., inert Ir-based redox mediator) may be activated and facilitate redox reactions between the chemical input and the body fluid.

Light, which includes a range of frequencies, may be emitted to and passed through the combined solution in step 740. In an aspect, step 740 may be performed prior to or simultaneously with step 730.

During redox reactions, an electrical output and an optical output (e.g., optical absorption) may be simultaneously measured in step 750. The electrical and optical outputs may be processed to generate a pattern between the electrical output and the optical output. A cross-modal response pattern may be determined as the pattern in step 760.

In various aspects, the pattern may be specific to redox substances. In other words, the pattern with GSH may be different from that with ascorbate or albumin. Thus, based on the pattern, characteristics of specific substances in the body fluid may be identified. Further, characteristics (e.g., biomarkers) of the body fluid may be further identified based on the cross-modal response.

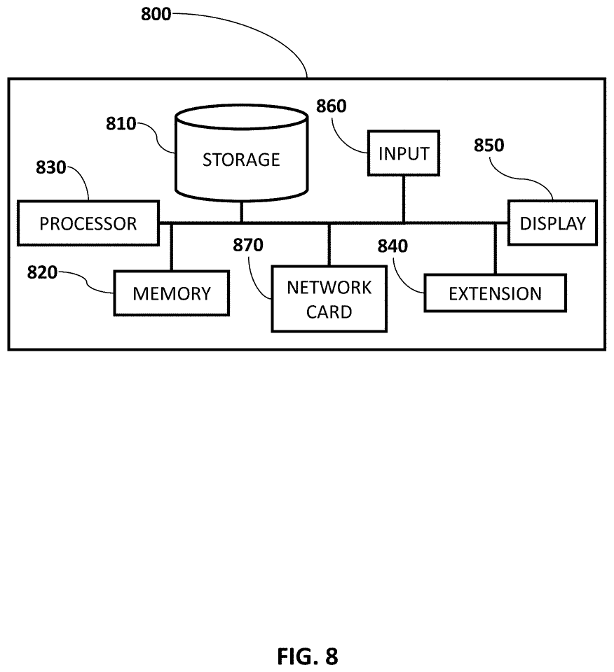

Now referring to FIG. 8, provided is a block diagram for a processing device 800 representative of the computing device 110 of FIG. 1 in accordance with aspects of the present disclosure. The computing device 800 may include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, embedded computers, and the likes. Those of skill in the art will recognize that many smartphones are suitable for use in the system described herein. Suitable tablet computers include those with booklet, slate, and convertible configurations, known to those of skill in the art.

In various aspects, the computing device 800 may include an operating system configured to perform executable instructions. The operating system is, for example, software, including programs and data, which manages hardware of the computing device 800 and provides services for execution of applications. Those of skill in the art will recognize that suitable server operating systems may include, by way of non-limiting examples, FreeBSD, OpenBSD, NetBSD®, Linux, Apple® Mac OS X Server®, Oracle® Solaris®, Windows Server®, Novell® NetWare®, and the likes. Those of skill in the art will recognize that suitable personal computer operating systems may include, by way of non-limiting examples, Microsoft® Windows®, Apple® Mac OS X®, UNIX®, and UNIX-like operating systems such as GNU/Linux®.

In various aspects, the operating system may be provided by cloud computing. Those of skill in the art will also recognize that suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In various aspects, the computing device 800 may include a storage 810. The storage 810 is one or more physical apparatuses used to store data or programs on a temporary or permanent basis. The storage 810 may be volatile memory and requires power to maintain stored information. In various aspects, the storage 810 may be non-volatile memory and retains stored information when the computing device 800 is not powered. In various aspects, the non-volatile memory includes flash memory. In various aspects, the non-volatile memory may include dynamic random-access memory (DRAM). In various aspects, the non-volatile memory may include ferroelectric random-access memory (FRAM). In various aspects, the non-volatile memory may include phase-change random access memory (PRAM). In various aspects, the storage 810 may include, by way of non-limiting examples, CD-ROMs, DVDs, flash memory devices, magnetic disk drives, magnetic tape drives, optical disk drives, solid-state drive, universal serial bus (USB) drive, and cloud computing-based storage. In various aspects, the storage 810 may be a combination of devices such as those disclosed herein.

The computing device 800 further includes a processor 830, an extension 840, a display 850, an input device 860, and a network interface 870. The processor 830 is a brain to the computing device 800. The processor 830 executes instructions which implement tasks or functions of programs. When a user executes a program, the processor 830 reads the program stored in the storage 810, loads the program on the RAM, and executes instructions prescribed by the program.

In various aspects, the processor 830 may include a microprocessor, central processing unit (CPU), application specific integrated circuit (ASIC), arithmetic coprocessor, graphic processor, or image processor, each of which includes electronic circuitry within a computer that carries out instructions of a computer program by performing the basic arithmetic, logical, control and input/output (I/O) operations specified by the instructions.

In various aspects, the extension 840 may include several ports, such as one or more USBs, IEEE 1394 ports, parallel ports, and/or expansion slots such as peripheral component interconnect (PCI) and PCI express (PCIe). The extension 840 is not limited to the list but may include other slots or ports that can be used for appropriate purposes. The extension 840 may be used to install hardware or add additional functionalities to a computer that may facilitate the purposes of the computer. For example, a USB port can be used for adding additional storage to the computer and/or an IEEE 1394 may be used for receiving moving/still image data.

In various aspects, the display 850 may be a cathode ray tube (CRT), a liquid crystal display (LCD), or light emitting diode (LED). In various aspects, the display 850 may be a thin film transistor liquid crystal display (TFT-LCD). In various aspects, the display 850 may be an organic light emitting diode (OLED) display. In various aspects, the OLED display is a passive-matrix OLED (PMOLED) or active-matrix OLED (AMOLED) display. In various aspects, the display 850 may be a plasma display. In various aspects, the display 850 may be a video projector. In various aspects, the display may be interactive that can detect user interactions/gestures/responses and the like. In still various aspects, the display 850 may be a combination of devices such as those disclosed herein.

A user may input and/or modify data via the input device 860 that may include a keyboard, a mouse, or any other device with which the use may input data. The display 850 displays data on a screen of the display 850. The display 850 may be a touch screen so that the display 850 can be used as an input device.

The network interface 870 is used to communicate with other computing devices, wirelessly or via a wired connection. Through the network interface 870, the computing device 800 may transmit, receive, modify, and/or update data from and to an outside computing device, server, or clouding space.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C #, Delphi, Fortran, Java, JavaScript, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in various aspects,” “in aspects,” “in various aspects,” “in various aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A method for measuring redox-based chemical signatures, the method comprising:
adding a chemical input to a body fluid;
applying an electrical signal to a combination of the chemical input and the body fluid;
measuring an electrical output and an optical output of the combination for a predetermined time period; and
determining a cross-modal response characteristic of an interaction between the electrical output and the optical output.

2. The method according to claim 1, wherein the chemical input is an iridium-based redox mediator.

3. The method according to claim 2, wherein the iridium-based redox mediator includes Ir or K₃IrCl₆.

4. The method according to claim 2, wherein the electric signal induces inert reduced iridium of the iridium-based redox mediator into an oxidized form.

5. The method according to claim 2, wherein the chemical input is configured to exchange electrons with components in the body fluid.

6. The method according to claim 5, wherein the components include glutathione, ascorbate, or albumin.

7. The method according to claim 6, wherein the cross-modal response of glutathione, ascorbate, or albumin has a different slope from each other.

8. The method according to claim 1, wherein the cross-modal response is a slope between the electrical output and the optical output.

9. The method according to claim 1, wherein the optical output is a measurement of light absorption at a predetermined wavelength.

10. A system for measuring redox-based chemical signatures of oxidative stress from body fluids, the system comprising:
an electric circuit configured to apply an electric signal to a combination of a chemical input and a body fluid for a predetermined period;
a potentiostat circuit configured to measure an electrical output from the combination when the electrical signal is applied to the combination;
an optical absorption meter configured to measure an optical output from the combination when the electrical signal is applied to the combination;
a processor; and
a memory storing instructions thereon that, which when executed by the processor, cause the system to determine a cross-modal response characteristic of an interaction between the electrical output and the optical output.

11. The system according to claim 10, wherein the chemical input is an iridium-based redox mediator.

12. The system according to claim 11, wherein the iridium-based redox mediator includes Ir or K₃IrCl₆.

13. The system according to claim 11, wherein the electric signal induces inert reduced iridium of the iridium-based redox mediator into an oxidized form.

14. The system according to claim 11, wherein the chemical input exchanges electrons with components in the body fluid.

15. The system according to claim 14, wherein the components include glutathione, ascorbate, or albumin.

16. The system according to claim 15, wherein the cross-modal response of glutathione, ascorbate, or albumin has a different slope from each other.

17. The system according to claim 10, wherein the cross-modal response is a slope between the electrical output and the optical output.

18. The system according to claim 10, wherein the optical output is a measurement of light absorption at a predetermined wavelength.

19. The system according to claim 18, wherein the predetermined wavelength is based on a component of the body fluid.

20. A non-transitory computer-readable storage medium including instructions stored thereon that, when executed by a computer, cause the computer to perform a method for measuring redox-based chemical signatures, the method comprising:
applying an electrical signal to a combination of a chemical input and a body fluid;
measuring an electrical output and an optical output of the combination for a predetermined time period; and
determining a cross-modal response characteristic of an interaction between the electrical output and the optical output.
